(19) United States
(12) Patent Application Publication
(10) Pub. No.: US 2002/0144159 A1
(43) Pub. Date: Oct. 3, 2002

(54) HomePNA device with the function of transmitting power over a network wire

(76) Inventors: Kuo-Yang Wu, Chu-Pei City (TW); Nien-Tzu Chang, Chu-Pei City (TW)

Correspondence Address: BIRCH STEWART KOLASCH & BIRCH, PO BOX 747, FALLS CHURCH, VA, 22040-0747, US

(21) Appl. No.: 09/821,035

(22) Filed: Mar. 30, 2001

(51) Int. Cl. G06F 1/26; G06F 1/28; G06F 1/30

(52) U.S. Cl. 713/300

(57) ABSTRACT

A HomePNA device with the function of transmitting power over a network wire, which connects to another HomePNA device via the network wire and transmits power using a non-data signal line in the communications protocol. The HomePNA device contains a first and second network wire connection ports for network wire terminals to plug in so as to receive and transmit data signals according to the communications protocol and to receive or transmit power provided via the non-data signal line; a power input port, which receives the external power provided through the power terminal and has a switch; and a plurality of sets of phone line connection ports for connecting data transmitting phone lines to the computer host. When the power input terminal is plugged with a power terminal, the switch is inactive and connects the non-data signal line of the first network connection port to the non-data signal line of the second network connection port and an internal control circuit. At the moment, the network device uses the power provided through the non-data signal line of the first network connection port to function. When the power input port is plugged with a power terminal, the switch functions and connects the power signal line of the power terminal to the non-data signal line of the second network connection port and the internal control circuit. In this case, the network device uses the power provided from the power terminal to function.

### BACKGROUND OF THE INVENTION

1. Field of Invention

The invention relates to a network device and, in particular, to a HomePNA device using a network wire to transmit power.

2. Related Art

With reference to FIG. 1, the I/O ports of a usual HomePNA device 100 contain several phone line connection ports 111, 112, . . . , 116, network connection ports 121, 122, and a power input port 131. A number of computers use phone lines to connect to the HomePNA device 100 through the phone line connection ports 111, 112, . . . , 116 to communicate with a network. Different HomePNA devices use their network connection ports 121, 122 to communicate with one another using a network communications protocol. The network connection port 121 can connect to the next HomePNA device and the network connection port 122 connects to the previous HomePNA device. The most commonly used network communications protocol nowadays is the Ethernet Protocol. The power of the HomePNA device 100 is provided by an adapter through the power input port 131.

Community networks are more and more popular. To avoid reconfigure network wires, people usually use HomePNA devices 100 to link computers in a community. If the HomePNA device 100 is only used within a family, the power can be readily obtained. However, if the HomePNA device 100 is installed in a public area in the community so as to link all users in the community, then the power supply will become a problem and cause troubles in the uses of the HomePNA device 100.

### SUMMARY OF THE INVENTION

In view of the foregoing, it is an object of the invention to provide a HomePNA device with the function of transmitting power over a network wire.

To achieve the above object, the disclosed HomePNA device contains a first network wire connection port and a second network wire connection port, a power input port, and several phone line connection ports. The first network wire connection port and the second network wire connection port are installed for network wire terminals to plug in. The HomePNA device can then receive and transmit data signals using a communications protocol and receive and transmit the power provided via a non-data signal wire. The power input port can receive external power provided from the power terminal and has a switch. The phone line connection ports connect data transmission phone lines to a computer host.

When the power input port is not plugged with a power terminal, the switch of the power input port is inactive and connects the non-data signal wire of the first network connection port to the non-data signal wire of the second network connection port and an internal control circuit. At the moment, the network device uses the power provided by the non-data signal wire at first network connection port to function. When the power input port is plugged with a power terminal, the switch starts to function and connects the power signal wire at the power input terminal to the non-data signal wire of the second network connection port and the internal control circuit. Now the network device uses the power provided through the power input terminal to function.

Therefore, the disclosed HomePNA device can use the power provided by the previous HomePNA device. Not every HomePNA device needs an external power supply. So the HomePNA device can be installed in a public area with no power socket.

### BRIEF DESCRIPTION OF THE DRAWINGS

The present invention will become more fully understood from the detailed description given hereinbelow illustration only, and thus are not limitative of the present invention, and wherein:

FIG. 1 shows the back panel of a conventional HomePNA device;

FIG. 2 shows a structure of the disclosed HomePNA device with the function of transmitting power over a network wire;

FIG. 3 shows a first embodiment of the disclosed HomePNA devices connected in series;

FIG. 4 shows a second embodiment of the disclosed HomePNA devices connected in series;

FIG. 5 shows a third embodiment of the disclosed HomePNA devices connected in series; and

FIG. 6 shows a fourth embodiment of the disclosed HomePNA devices connected in series.

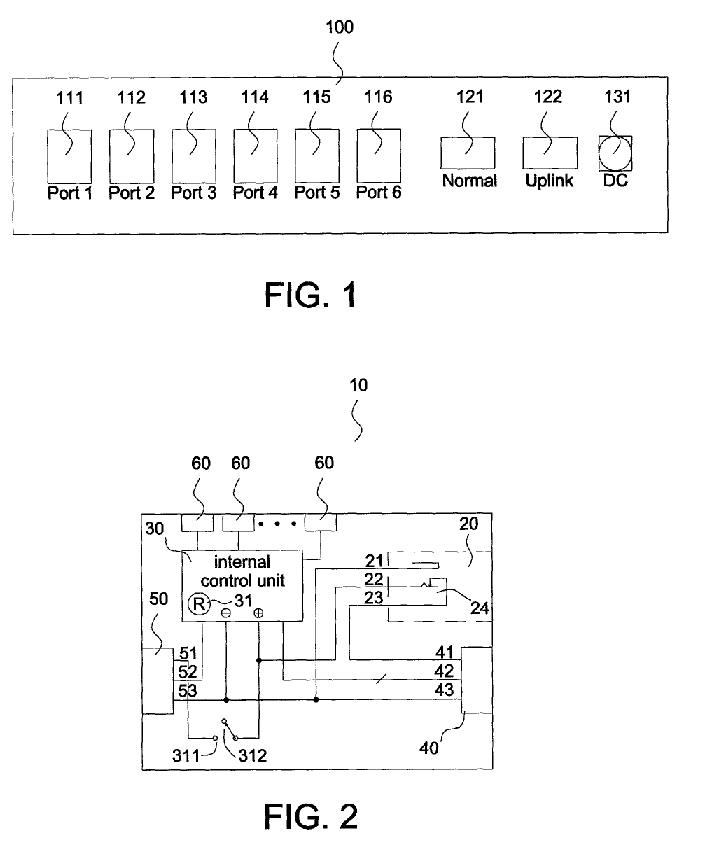

### DETAILED DESCRIPTION OF THE INVENTION

The disclosed HomePNA device will be apparent from the following detailed description, which proceeds with reference to the accompanying drawings.

With reference to FIG. 2, the HomePNA device 10 contains a DC power socket 20, an internal control unit 30, a first network connection port 40, a second network connection port 50, and several phone line connection ports 60.

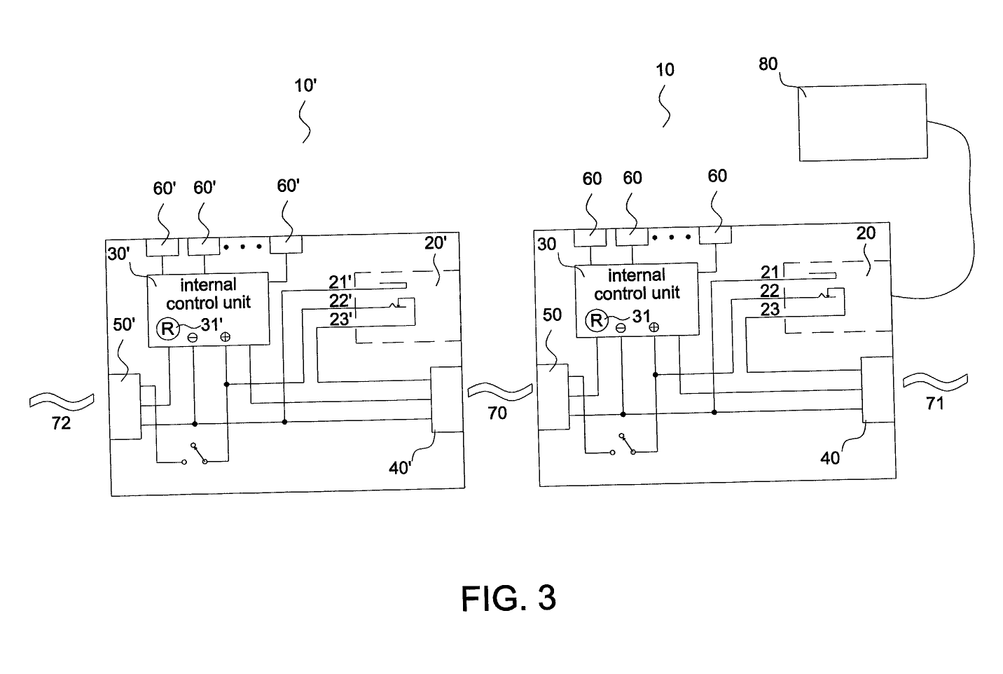

The DC power socket 20 contains a two-way switch 24, which connects wires 22, 23 when the adapter 80 (see FIG. 3) is not plugged into the DC power socket 20 so that the power input from the first network connection port 40 can be directed to the internal control unit 30. After the power adapter is plugged into the DC power socket 20, the connection between the wires 22, 23 is broken and the power supply plug gets into contact with the two-way switch 24, transferring the power from the power adapter to the internal control unit 30. Therefore, the HomePNA device 10 can use the DC power socket 20 to automatically determine which power source to use, the external power supply or the first network connection port 40.

The functions of the internal control unit 30 are to receive the data transmitted from the phone line ports 60, the first network connection port 40 and the second network connection port 50 and to perform data exchange and control according to the communications protocol. Since the functions of the internal control unit 30 are well known, the internal structure is not further explained herein. However, the internal control unit 30 further contains a power controller 31, such as a relay or other electronic circuits. This embodiment uses a relay to explain the action of the power controller 31. The relay 31 acts when the internal control unit 30 obtains sufficient power. The connection points 311, 312 are the connection points a, b of the relay 31. When the relay 31 is not active, the connection point 312 is in conduction and the power is not transferred to the second network connection port 50. When the relay is active, the connection point 311 is in conduction and the power is provided from the external power supply or from the first network connection port 40 to the second network connection port 50. The reason to use the power controller 31 is to protect the external power supply, avoiding the serially connected several HomePNA device 10 from action at the same time and resulting instantaneous overload of the external power supply.

The first network connection port 40 receives the signals from the previous device via a network wire. If one of the HomePNA devices 10 does not have power supply from an external power supply, then the previous HomePNA device 10 has to provide power to the second network connection port 50 of the current HomePNA device 10. The first network connection port 40 uses the IEEE STD 802.3 Part3. Its pin 4 and pin 5 are not used by 10BASE-T or 100BASE-TX, and its pin 7 and pin 8 are not in use. Therefore, the disclosed HomePNA device 10 utilizes those transmission wires not in use to transmit power. For example, the connection wire 41 in FIG. 2 connects to pin 7 and pin 8 of the first network connection port 40 and provides a positive voltage. The connection wire 43 connects to pin 4 and pin 5 of the first network connection port 40 and provides the ground. Of course, the connection points of the first network connection port 40 corresponding to the connection wires 41 and 43 can be adjusted according to needs. Secondly, the connection wire 42 is a data bus connecting to pins 1, 2, 3, and 6 of the first network connection port 40.

The second network connection port corresponds to the first network connection port 40 and sends data and power to the next device. The connection wire 51 in FIG. 2 can connect to pin 7 and pin 8 of the second network connection port 50 to transmit the positive voltage of the power. The connection wire 53 can connect to pin 4 and pin 5 of the second network connection port 50 to transmit the ground of the power. Furthermore, the connection wire 52 is a data bus connecting to pins 1, 2, 3, and 6 of the second network connection port 50. The positive voltage of the power on the connection wire 51 is controlled by the relay 31. That is, only when the internal control unit 30 gets sufficient power does the relay start to action and put the connection point 311 into conduction.

As shown in FIG. 3, the two HomePNA devices 10, 10′ are connected through a network wire 70. The HomePNA device 10 is powered by an external power supply 80, and the HomePNA device 10′ is powered through the network wire 70. A network wire 71 connects the HomePNA device 10 to its previous HomePNA device (not shown). The network wire may or may not transmit power. A network wire 72 connects the HomePNA device 10′ to the next HomePNA device (not shown) and transmits power. Since no external power supply is plugged into the HomePNA device 10′, the connection wires 22′ and 23′ are in conduction to provide the power input through the first network connection port 40′ to the internal control unit 30′.

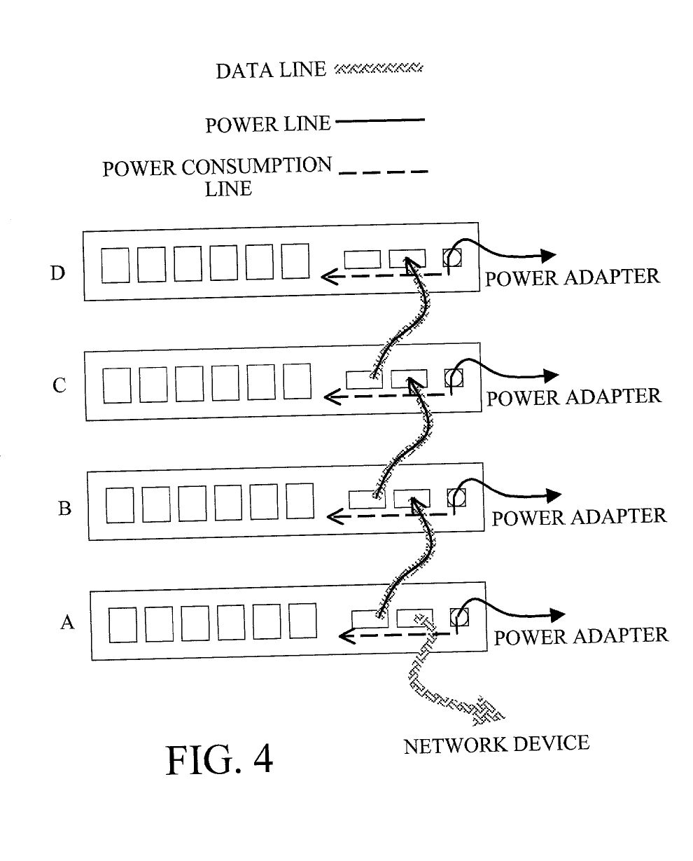

FIGS. 4, 5, and 6 show several different connection methods, where dashed, solid, and netted lines represent the power flows, the power supply routes, and the data lines, respectively.

In FIG. 4, each HomePNA device connects to an external power supply. Each HomePNA device uses its own external power supply to function. Although each HomePNA device also provides power to the next one, no power is flowing across devices because it is unnecessary.

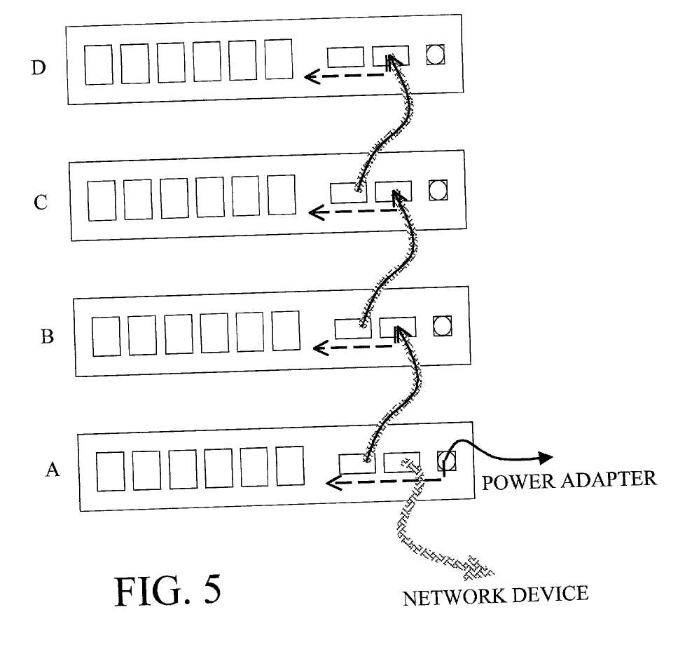

In FIG. 5, only one HomePNA device A connects to an external power supply. Thus, the HomePNA devices A, B, C, and D are using the power from the external power supply directly connected to the HomePNA device A.

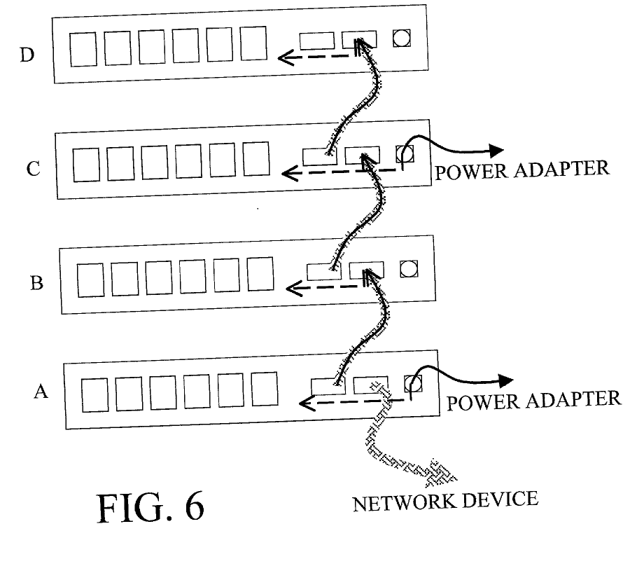

In FIG. 6, both the HomePNA device A and the HomePNA device C connect to their external power supplies, respectively. Therefore, the HomePNA devices A and B use the power from the external power supply to the HomePNA device A, while the HomePNA devices C and D use the power from the external power supply to the HomePNA device C.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A HomePNA device with the function of transmitting power over a network wire, the HomePNA device communicating with other HomePNA device via a network wire according to a network protocol, said HomePNA device comprising:
at least a first kind of network wire connection ports to receive a network wire terminal so as to receive and transmit data signals according to the communications protocol and to receive power provided via the non-data signal line;
at least a second kind of network wire connection ports to receive a network wire terminal so as to receive and transmit data signals according to the communications protocol and to transmit power provided via the non-data signal line;
a plurality of sets of phone line connection ports for connecting data transmitting phone lines to host;
an internal control unit for controlling the function of the network device; and
a power input port for receiving external power provided through a power terminal of a power adapter and having a switch; wherein
when said power input port does not receive the power terminal, said switch connects the non-data signal line of said first kind of network connection port to the non-data signal line of the second kind of network connection port and said internal control unit, and the HomePNA device consumes the power provided through the non-data signal line of the first kind of network connection port; and
when said power input port receives the power terminal, said switch connects the power signal line of the power terminal to the non-data signal line of the second network connection port and the internal control unit, and the HomePNA device consumes the power provided from the power terminal.

2. The HomePNA device as claimed in claim 1, wherein said internal control unit comprises a power controller to provide power to said non-data signal line of the second network connection port when said internal control unit get enough power to avoid the power adapter from overhead.

3. The HomePNA device as claimed in claim 1, wherein said network protocol is Ethernet protocol.

4. A HomePNA system with the function of transmitting power over a network wire, the HomePNA system connecting a plurality of HomePNA device via network wires according to a network protocol, said each HomePNA device comprising:
at least a first kind of network wire connection ports to receive a network wire terminal so as to receive and transmit data signals according to the communications protocol and to receive power provided via the non-data signal line;
at least a second kind of network wire connection ports to receive a network wire terminal so as to receive and transmit data signals according to the communications protocol and to transmit power provided via the non-data signal line;
a plurality of sets of phone line connection ports for connecting data transmitting phone lines to host;
an internal control unit for controlling the function of the network device; and
a power input port for receiving external power provided through a power terminal of a power adapter and having a switch; wherein
when said power input port does not receive the power terminal, said switch connects the non-data signal line of said first kind of network connection port to the non-data signal line of the second kind of network connection port and said internal control unit, and the HomePNA device consumes the power provided through the non-data signal line of the first kind of network connection port; and
when said power input port receives the power terminal, said switch connects the power signal line of the power terminal to the non-data signal line of the second network connection port and the internal control unit, and the HomePNA device consumes the power provided from the power terminal.

5. The HomePNA system as claimed in claim 4, wherein said internal control unit comprises a power controller to provide power to said non-data signal line of the second network connection port when said internal control unit get enough power to avoid the power adapter from overhead.

6. The HomePNA system as claimed in claim 4, wherein said network protocol is Ethernet protocol.
